(19) United States
(12) Patent Application Publication
(10) Pub. No.: US 2005/0163508 A1
(43) Pub. Date: Jul. 28, 2005

(54) Wavelength division multiplexed passive optical network

(76) Inventors: Seong-Taek Hwang, Pyeongtaek-si (KR); Gyu-Woong Lee, Suwon-si (KR); Kwan-Soo Lee, Seoul (KR); Yun-Je Oh, Yongin-si (KR)

Correspondence Address: ANGELA DENESE LASSITER, 304 NELSON CT., CHAMPAIGN, IL, 61820, US

(21) Appl. No.: 10/915,152

(22) Filed: Aug. 9, 2004

(30) Foreign Application Priority Data
Jan. 27, 2004 (KR) 2004-4989

(51) Int. Cl. H04J 14/00

(52) U.S. Cl. 398/71

(57) ABSTRACT

A wavelength division multiplexed passive optical network (WDM PON) includes a central office that has: a broadband light source, a first wavelength division multiplexer to spectrum-slice light outputted from the light source, semiconductor optical amplifiers or variable optical attenuators, each modulating an associated one of spectrum-sliced lights in accordance with input data, and a second wavelength division multiplexer to multiplex optical signals respectively outputted from the semiconductor optical amplifiers. A remote node, connected to the central office via a main optical fiber, distributes the optical signals to distribution optical fibers, and, in, turn, to respective optical network units.

### CLAIM OF PRIORITY

This application claims priority to an application entitled “WAVELENGTH DIVISION MULTIPLEXED PASSIVE OPTICAL NETWORK,” filed in the Korean Intellectual Property Office on Jan. 27, 2004 and assigned Serial No. 2004-4989, the contents of which are hereby incorporated by reference.

### BACKGROUND OF THE INVENTION

1. Field of the Invention

The present invention relates to a passive optical network, and more particularly to a wavelength division multiplexed passive optical network using a spectrum-sliced light source.

2. Description of the Related Art

A wavelength division multiplexed (WDM) passive optical network (PON) can provide ultrahigh-speed broadband communication services, using particular wavelengths assigned to respective subscribers. Accordingly, the WDM PON ensures communication security, and easily accommodates a separate communication service required by a subscriber, and expansion of communication capacity. To this latter point, the WDM PON allows addition of a particular wavelength to be assigned to a new subscriber, so that it is possible to easily achieve an increase in the number of subscribers.

In spite of the advantages, however, the WDM PON additionally requires, for its central office (CO) and each optical network unit (ONU), light sources with a particular oscillation wavelength, and wavelength stabilizing circuits adapted to stabilize the wavelength of the respective light sources. As a result, a heavy burden is imposed on subscribers. The WDM PON is therefore not yet in widespread use. Implementation of the WDM accordingly requires that an economical WDM light source be developed.

Proposed light sources for a WDM PON include a distributed feedback (DFB) laser, a multi-frequency laser (MFL), a picosecond pulse light source, or the like.

FIG. 1 is a schematic diagram illustrating a conventional WDM PON using a spectrum-sliced light source. The PON 100 in FIG. 1 includes a central office (CO) 110, a remote node (RN) 170 connected to the central office 110 via a main optical fiber (MF) 160, and a plurality of optical network units (ONUs), ONU₁ 200-1 to ONUₙ 200-n, connected to the remote node 170 via a plurality of distribution optical fibers (DFs), DF₁ 190-1 to DFₙ 190-n, respectively.

The central office 110 includes a broadband light source (BLS) 120, a first wavelength division multiplexer (WDM1) 130, n LiNbO₃ modulators (MOD₁ to MODₙ) 140-1 to 140n, and a second wavelength division multiplexer (WDM2) 150.

The WDM1 130 has a multiplexing port MP, and n demultiplexing ports DP₁ to DPₙ. The multiplexing port MP of the WDM1 130 is connected to the broadband light source 120, whereas the n demultiplexing ports DP₁ to DPₙ of the WDM1 130 are connected to the LiNbO₃ MOD₁ 140-1 to LiNbO₃ MODₙ 140-n, respectively. The WDM1 130 spectrum-slices (or demultiplexes) broadband light outputted from the broadband light source 120 into n lights of different-wavelengths, and outputs the different-wavelength lights to the respective demultiplexing ports DP₁ to DPₙ. Specifically, the light having the k-th wavelength is outputted to the k-th demultiplexing port DPₖ of the WDM1 130, where 1≦k≦n.

The LiNbO₃ MOD₁ 140-1 to LiNbO₃ MODₙ 140-n are connected between the WDM1 130 and the WDM2 150 such that each of them connects demultiplexing ports of the WDM1 130 to corresponding multiplexing ports of WDM2 150. Accordingly, each of the LiNbO₃ MOD₁ 140-1 to LiNbO₃ MODₙ 140-n generates a respective optical signal by using received external data to modulate light with an associated wavelength received from the WDM1 130. For example, the LiNbO₃ MODₙ 140-n connects the n-th demultiplexing ports DPₙ of the WDM1 130 and WDM2 150. Accordingly, the LiNbO₃ MODₙ 140-n modulates light with the n-th wavelength received from the WDM1 130, using external data that has been received, and thus, generates an n-th optical signal.

The WDM2 150 has a multiplexing port MP, and n demultiplexing ports DP₁ to DPₙ. The multiplexing port MP of the WDM2 150 is connected to the main optical fiber 160, whereas the n demultiplexing ports DP₁ to DPₙ of the WDM2 150 are connected to the LiNbO₃ MOD₁ 140-1 to LiNbO₃ MODₙ 140-n, respectively. The WDM2 150 multiplexes n optical signals respectively inputted to the demultiplexing ports DP₁ to DPₙ thereof, and outputs the multiplexed optical signal through the multiplexing port MP.

The remote node 170 is connected to the central office 110 via the main optical fiber 160, while being connected to the ONU₁ 200-1 to ONUₙ 200-n via the distribution optical fibers 190-1 to 190-n, respectively. The remote node 170 includes a third wavelength division multiplexer (WDM3) 180.

The WDM3 180 has a multiplexing port MP connected to the main optical fiber 160, and n demultiplexing ports DP₁ to DPₙ connected to the n distribution optical fibers 190-1 to 190-n, respectively. The WDM3 180 demultiplexes n optical signals inputted into its multiplexing port MP, and outputs the demultiplexed n optical signals to the n demultiplexing ports DP₁ to DPₙ thereof, respectively.

ONU₁ 200-1 to ONUₙ 200-n are connected to the n distribution optical fibers 190-1 to 190-n, respectively. For example, the ONUₙ 200-n is connected to the n-th distribution optical fiber 190-n. Each ONU receives an optical signal from the associated distribution optical fiber, and opto-electrically detects the received signal. For example, the ONUₙ 200-n receives an optical signal from the n-th distribution optical fiber 190-n, and opto-electrically detects the received signal.

However, the LiNbO₃ modulators conventionally employed in the WDM PON are expensive. Additionally, they exhibit a severe characteristic variation depending on the polarized state of the incoming light, and suffer high insertion loss. It is accordingly necessary in some cases to provide additional optical amplifiers, e.g., in the central office, to compensate for a loss margin which varies with the transmission distance of the multiplexed optical signals. The resulting overhead leads to additional expense and lost competitiveness.

### SUMMARY OF THE INVENTION

The present invention has been made to address the above-mentioned shortcomings of the related art. An object of the invention is to provide a WDM PON that can be inexpensively implemented while using a spectrum-sliced light source involving simple wavelength management, and without using expensive modulators.

In accordance with the present invention, this object is accomplished by providing a central office, of an optical network, that includes a broadband light source, a first wavelength division multiplexer configured to spectrum-slice light outputted from the broadband light source, semiconductor optical amplifiers each configured to modulate, in accordance with data that has been inputted, an associated one of spectrum-sliced lights outputted from the first wavelength division multiplexer and to output the modulated lights. The central office further includes a second wavelength division multiplexer configured to multiplex the outputted, modulated lights.

### BRIEF DESCRIPTION OF THE DRAWINGS

The above objects and advantages of the present invention will become more apparent by describing in detail preferred embodiments thereof with reference to the attached drawings in which the same or similar elements are identically annotated throughout the several views:

FIG. 1 is a schematic diagram illustrating a conventional WDM PON;

FIG. 2 is a schematic diagram illustrating a configuration of a WDM PON according to a first embodiment of the present invention, in which semiconductor optical amplifiers (SOAs) are used; and

FIG. 3 is a schematic diagram illustrating a configuration of a WDM PON according to a second embodiment of the present invention, in which variable optical attenuators (VOAs) are used.

### DETAILED DESCRIPTION

Preferred embodiments of the present invention are described below in detail with reference to the annexed drawings. Details of known functions and configurations incorporated herein are omitted for clarity of presentation.

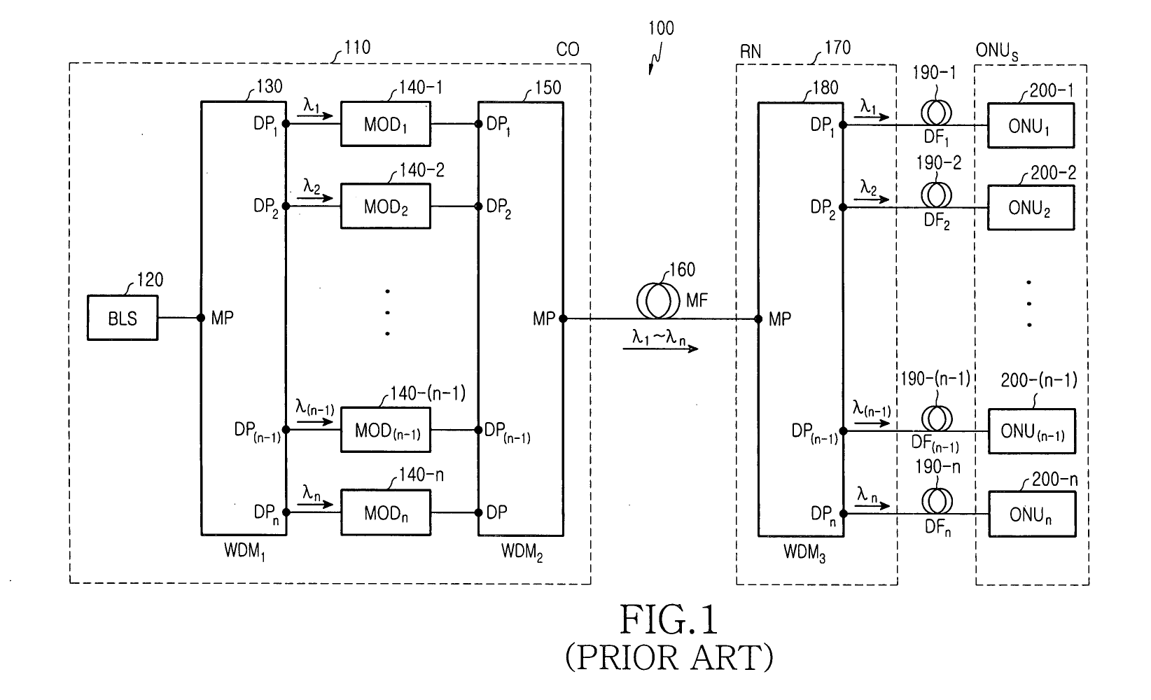

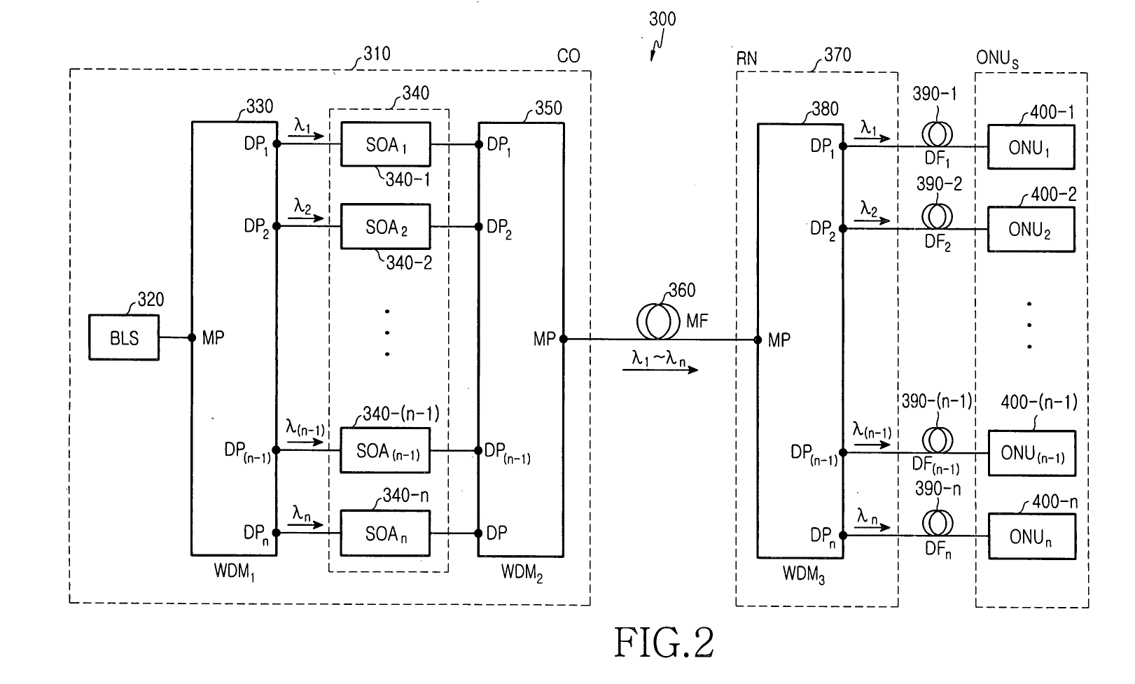

FIG. 2 illustrates a configuration of a WDM PON according to a first embodiment of the present invention, which differs from the prior art embodiment of FIG. 1 in that the LiNbO₃ modulators 140-1 to 140-n, and possibly additional loss-insertion-compensating amplifiers, are replaced with an array 340 of semiconductor optical amplifiers (SOAs) SOA₁ 340-1 to SOAₙ 340-n. The PON, which is designated by reference numeral 300 in FIG. 2, includes a central office (CO) 310, a remote node (RN) 370 connected to the central office 310 via a main optical fiber (MF) 360, and a plurality of optical network units (ONUs), ONU₁ 400-1 to ONUₙ 400-n, connected to the remote node 370 via a plurality of distribution optical fibers (DFs), DF₁ 390-1 to DFₙ 390-n, respectively.

The central office 110 includes a broadband light source 320, a first wavelength division multiplexer (WDM1) 330, n semiconductor optical amplifiers (SOAs), SOA₁ 340-1 to SOAₙ 340-n, and a second wavelength division multiplexer (WDM2) 350. The WDM1 330 has a multiplexing port MP, and n demultiplexing ports DP₁ to DPₙ. The multiplexing port MP of the WDM1 330 is connected to the broadband light source 320, whereas the n demultiplexing ports DP₁ to DPₙ of the WDM1 330 are connected to the SOA₁ 340-1 to SOAₙ 340-n, respectively. The WDM1 330 spectrum-slices (or demultiplexes) broadband light outputted from the broadband light source 320 and inputted at the multiplexing port MP thereof, into n lights of different-wavelengths, and outputs the different-wavelength lights to respective demultiplexing ports DP₁ to DPₙ thereof. Specifically, the light having the k-th wavelength is outputted to the k-th demultiplexing port DPₖ of the WDM1 330, where 1≦k≦n. Each of the WDM1 330 and WDM2 350 may include an arrayed waveguide grating (AWG).

The SOA₁ 340-1 to SOAₙ 340-n are connected between the WDM1 330 and the WDM2 350 such that each of them connects demultiplexing ports of the WDM1 330 to corresponding multiplexing ports of WDM2 350. Accordingly, each of the SOA₁ 340-1 to SOAₙ 340-n generates a respective optical signal by using received external data to modulate light with an associated wavelength received from the WDM1 330. For example, the SOAₙ 340-n connects the n-th demultiplexing ports DPₙ of the WDM1 330 and WDM2 350. Accordingly, the SOAₙ 340-n modulates light with the n-th wavelength received from the WDM1 330, using external data that has been received, and thus, generates an n-th optical signal.

Each of SOA₁ 340-1 to SOAₙ 340-n not only serves as a modulator, but also serves as an amplifier having a gain. Thus, the SOA₁ 340-1 to SOAₙ 340-n can compensate for an insertion loss generated in each of the WDM1 330 and WDM2 350 and an insertion loss generated due to a difference between the central wavelengths of the WDM1 330 and WDM2 350. Advantageously, the PON 300 can therefore be designed with a lower system margin.

The WDM2 350 has a multiplexing port MP, and n demultiplexing ports DP₁ to DPₙ. The multiplexing port MP of the WDM2 350 is connected to the main optical fiber 360, whereas the n demultiplexing ports DP₁ to DPₙ of the WDM2 350 are connected to the SOA₁ 340-1 to SOAₙ 340-n, respectively. The WDM2 350 multiplexes n optical signals respectively inputted to the demultiplexing ports DP₁ to DPₙ thereof, and outputs the multiplexed optical signals through the multiplexing port MP.

The remote node 370 is connected to the central office 310 via the main optical fiber 360, while being connected to the ONU₁ 400-1 to ONUₙ 400-n via the distribution optical fibers 390-1 to 390-n, respectively. The remote node 370 includes a third wavelength division multiplexer (WDM3) 380.

The WDM3 380 has a multiplexing port MP connected to the main optical fiber 360, and n demultiplexing ports DP₁ to DPₙ connected to the n distribution optical fibers 390-1 to 390-n, respectively. The WDM3 380 demultiplexes n optical signals inputted into its multiplexing port MP, and outputs the demultiplexed n optical signals to the n demultiplexing ports DP₁ to DPₙ thereof, respectively. The WDM3 380 may include an AWG.

ONU₁ 400-1 to ONUₙ 400-n are connected to the n distribution optical fibers 390-1 to 390-n, respectively. For example, the ONUₙ 400-n is connected to the n-th distribution optical fiber 390-n. Each ONU receives an optical signal from the associated distribution optical fiber, and opto-electrically detects the received signal.

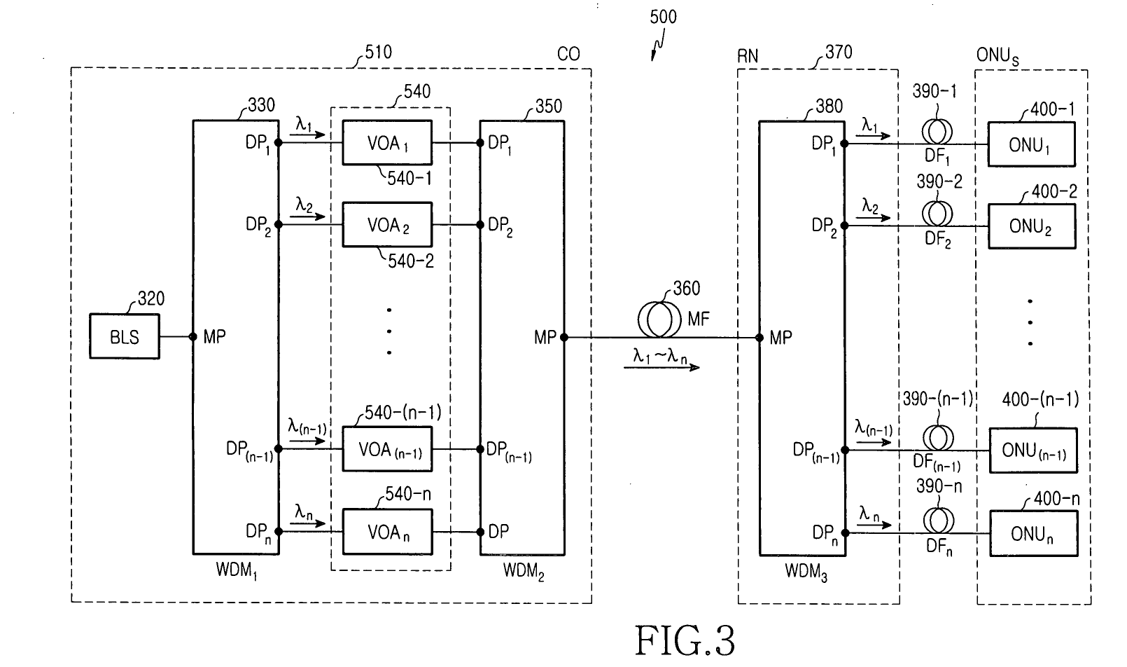

FIG. 3 illustrates a configuration of a WDM PON according to a second embodiment of the present invention. The PON 500 in FIG. 3 has a configuration similar to that of FIG. 2, except that it uses a variable optical attenuator (VOA) array 540 in place of the SOA array 340 used in the configuration of FIG. 2. The array 540 includes VOAs 540-1 to 540-n.

The PON 500 includes a central office (CO) 510 that incorporates the VOA array 540, and, as in the previous embodiment, the remote node (RN) 370, main optical fiber (MF) 360, the distribution optical fibers (DFs) 390-1 to 390-n and the plurality of optical network units (ONUs) 400-1 to 400-n.

Each of the VOA₁ 540-1 to VOAₙ 540-n generates a respective optical signal by using received external data to modulate light with an associated wavelength received from the WDM1 530. The VOAs 540-1 to 540-n of the second embodiment of the present invention and the SOAs 340-1 to 340-n of the first embodiment of the present invention both variably adjust the optical power of light, but differ in that the VOAs attenuate, rather than amplify, light.

As apparent from the above description, the WDM PON of the present invention reduces operation and maintenance costs by using a spectrum-sliced light source that involves simple wavelength management. The WDM PON of the present invention advantageously allows configuration of an economical network, using inexpensive semiconductor optical amplifiers or variable optical attenuators, in place of expensive modulators.

While this invention has been described in connection with what are presently considered to be the most practical and preferred embodiments, it is to be understood that the invention is not limited to the disclosed embodiments, but, to the contrary, is intended to cover various modifications within the spirit and scope of the appended claims.

1. A central office of an optical network, said central office comprising a broadband light source, a first wavelength division multiplexer configured to spectrum-slice light outputted from the broadband light source, a plurality of semiconductor optical amplifiers each configured to modulate, in accordance with data that has been inputted, an associated one of spectrum-sliced lights outputted from the first wavelength division multiplexer and to output the modulated lights, and a second wavelength division multiplexer configured to multiplex the outputted, modulated lights.

2. The central office of claim 1, wherein said central office is a central office of a wavelength division multiplexed passive optical network (WDM PON).

3. The central office of claim 2, comprising the central office and further comprising:
a remote node connected to the central office by a main optical fiber, connected to distribution optical fibers and configured to receive, over the main optical fiber, the lights multiplexed by the second wavelength division multiplexer and to distribute the received lights to the distribution optical fibers; and
a plurality of optical network units respectively connected to the remote node by the distribution optical fibers, so as to respectively receive the distributed lights.

4. The central office according to claim 3, wherein each of the first and second wavelength division multiplexers comprises an arrayed waveguide grating.

5. The central office according to claim 2, wherein each of the first and second wavelength division multiplexers comprises an arrayed waveguide grating.

6. The central office according to claim 1, wherein each of the first and second wavelength division multiplexers comprises an arrayed waveguide grating.

7. A central office of an optical network, said central office comprising a broadband light source, a first wavelength division multiplexer configured to spectrum-slice light outputted from the broadband light source, a plurality of variable optical attenuators each configured to modulate, in accordance with data that has been inputted, an associated one of spectrum-sliced lights outputted from the first wavelength division multiplexer and to output the modulated lights, and a second wavelength division multiplexer configured to multiplex the outputted, modulated lights.

8. The central office of claim 7, wherein said central office is a central office of a wavelength division multiplexed passive optical network (WDM PON).

9. The central office of claim 8, further comprising:
a remote node connected to the central office by a main optical fiber, connected to distribution optical fibers and configured to receive, over the main optical fiber, the lights multiplexed by the second wavelength division multiplexer and to distribute the received lights to the distribution optical fibers; and
a plurality of optical network units respectively connected to the remote node by the distribution optical fibers, so as to respectively receive the distributed lights.

10. The central office according to claim 9, wherein each of the first and second wavelength division multiplexers comprises an arrayed waveguide grating.

11. The central office according to claim 8, wherein each of the first and second wavelength division multiplexers comprises an arrayed waveguide grating.

12. The central office according to claim 7, wherein each of the first and second wavelength division multiplexers comprises an arrayed waveguide grating.

13. A central office of an optical network, said central office comprising a first wavelength division multiplexer configured to spectrum-slice broadband light outputted from a broadband light source, a plurality of variable optical power adjustors each configured to modulate, in accordance with data that has been inputted, an associated one of spectrum-sliced lights outputted from the first wavelength division multiplexer and to output the modulated lights, and a second wavelength division multiplexer configured to multiplex the outputted, modulated lights.

14. The central office of claim 13, wherein said central office is a central office of a wavelength division multiplexed passive optical network (WDM PON).

15. The central office of claim 14, wherein the plural variable optical power adjustors comprise a semiconductor optical amplifier configured for the modulation.

16. The central office of claim 14, wherein the plural variable optical power adjustors comprise a variable optical attenuator configured for the modulation.

17. The central office of claim 14, further comprising:
a remote node connected to the central office by a main optical fiber, connected to distribution optical fibers and configured to receive, over the main optical fiber, the lights multiplexed by the second wavelength division multiplexer and to distribute the received lights to the distribution optical fibers; and
a plurality of optical network units respectively connected to the remote node by the distribution optical fibers, so as to respectively receive the distributed lights.

18. The central office of claim 17, wherein the plural variable optical power adjustors comprise a semiconductor optical amplifier configured for the modulation.

19. The central office of claim 17, wherein the plural variable optical power adjustors comprise a variable optical attenuator configured for the modulation.

20. The central office of claim 13, further comprising the broadband light source.
